(19) United States
(12) Patent Application Publication
(10) Pub. No.: US 2025/0285145 A1
(43) Pub. Date: Sep. 11, 2025

(54) USE OF DOUBLE MACHINE LEARNING IN DETERMINING EFFECTS OF A FEATURE ON A PRODUCT

(71) Applicant: Microsoft Technology Licensing, LLC, Redmond, WA (US)

(72) Inventors: Manoj Kumar RAWAT, Bellevue, WA (US); Brittany Alyssa DOUGALL, Sandy Springs, GA (US); Andres Felipe SALCEDO, Seattle, WA (US)

(73) Assignee: Microsoft Technology Licensing, LLC, Redmond, WA (US)

(21) Appl. No.: 18/598,588

(22) Filed: Mar. 7, 2024

(51) Int. Cl. G06Q 30/0282; G06Q 10/0637; G06Q 30/0201

(52) U.S. Cl. CPC G06Q 30/0282; G06Q 10/06375; G06Q 30/0201

(57) ABSTRACT

A method and system for determining the causal effect of a treatment on a product includes extracting telemetry data from a use of the product, and net promoter score values associated with the product in a plurality of batches. The telemetry data and net promoter score values are aggregated into an aggregated data structure to generate a plurality of aggregated data structures, where each aggregated data structure of the plurality of data structures corresponds to one batch. The plurality of data structures are then appended to generate an aggregated dataset and data preprocessing is performed on the aggregated dataset to generate a filtered dataset. A request is then transmitted to a double machine learning (DML) cluster to generate treatment effect scores for the filtered dataset, the DML cluster including a treatment model and an effect model, wherein each of the models receives the confounding variables to be used in debiasing. The treatment effect scores are received as an output from the DML cluster and a visual representation of the treatment effect scores is generated via a data visualization engine.

### BACKGROUND

Many developers of software programs and/or other products evaluate the effects of various features on their software programs or overall products. Additionally, some enterprises rely on user ratings to measure customer satisfaction and identify areas for improvement. One of the most commonly utilized user rating metrics is the Net Promotor Score (NPS) or Satisfaction rating (SAT). The NPS offers a simple mechanism for measuring customer satisfaction. On an NPS survey, users are offered a rating scale (e.g., a scale of 0 to 5 or a scale of 0 to 10) to rate a company, service, product, or product feature. The rating is representative of the likelihood of the user recommending the company, service or product to another person. To calculate the NPS, the percentage of users that are unlikely to recommend the company, service or product (e.g., those providing a rating score of 0 to 6 on a scale of 0 to 10) is deducted from the percentage of users that are highly likely to promote the company, service or product (e.g. those with scores of 9 or 10 on a scale of 0 to 10).

In addition to reviewing NPS, it is sometimes useful for enterprises to monitor how user behavior changes over time and to determine the effects of a specific feature or action on customer satisfaction. Since higher NPS scores are correlated with increased customer loyalty and satisfaction, NPS can be examined to understand the impact that in-product functionalities have on it. However, current methods of examining NPS to determine effects of in-product functionalities or features on a product that are difficult to use, require extensive computing resources and take a significant amount of time. As a result, companies often need to conduct other types of studies such as A/B, conjoint/discreet choice for feature importance or impact on metric of interest.

Hence, there is a need for improved systems and methods of determining the impact of a feature for a product.

### SUMMARY

In one general aspect, the instant application describes a data processing system having a processor and a memory in communication with the processor wherein the memory stores executable instructions that, when executed by the processor, cause the data processing system to perform multiple functions. The functions may include extracting telemetry data and net promoter score values in a plurality of batches from one or more data stores, at least one of the telemetry data or the net promotor score values including confounding variables; aggregating the telemetry data and net promoter score values from each batch of the plurality of batches into an aggregated data structure to generate a plurality of aggregated data structures, each aggregated data structure of the plurality of data structures corresponding to a batch of the plurality of batches; appending the plurality of data structures to generate an aggregated dataset via a batch aggregation element; performing data preprocessing on the aggregated dataset to generate a filtered dataset with at least one of one or more debiasing fields, an outcome variable, and one or more treatment fields; transmitting a request to a double machine learning (DML) cluster to generate treatment effect scores for the filtered dataset, the DML cluster including a treatment model and an effect model, wherein each of the treatment and effect models receives the confounding variables for use in debiasing; receiving the treatment effect scores as an output from the DML cluster; and generating a visual representation of the treatment effect scores via a data visualization engine.

In yet another general aspect, the instant application describes a method for determining the effect of a treatment on a product. The method may include extracting telemetry data from a use of the product, and net promoter score values associated with the product in a plurality of batches, at least one of the telemetry data or the net promotor score values including confounding variables; aggregating the telemetry data and net promoter score values from each batch of the plurality of batches into an aggregated data structure to generate a plurality of aggregated data structures, each aggregated data structure of the plurality of data structures corresponding to a batch of the plurality of batches; appending the plurality of data structures to generate an aggregated dataset via a batch aggregation element; performing data preprocessing on the aggregated dataset to generate a filtered dataset with at least one of one or more debiasing fields, an outcome variable, and one or more treatment fields; transmitting a request to a double machine learning (DML) cluster to generate treatment effect scores for the filtered dataset, the DML cluster including a treatment model and an effect model, wherein each of the treatment and effect models receives the confounding variables to for use in debiasing; receiving the treatment effect scores as an output from the DML cluster; and generating a visual representation of the treatment effect scores via a data visualization engine.

In a further general aspect, the instant application describes a non-transitory computer readable medium on which are stored instructions that when executed cause a programmable device to extracting telemetry data, and net promoter score values in a plurality of batches from one or more data stores, at least one of the telemetry data or the net promotor score values including confound variables; aggregating the telemetry data and net promoter score values from each batch of the plurality of batches into an aggregated data structure to generate a plurality of aggregated data structures, each aggregated data structure of the plurality of data structures corresponding to a batch of the plurality of batches; appending the plurality of data structures to generate an aggregated dataset via a batch aggregation element; performing data preprocessing on the aggregated dataset to generate a filtered dataset with at least one of one or more debiasing fields, an outcome variable, and one or more treatment fields; transmitting a request to a double machine learning (DML) cluster to generate treatment effect scores for the filtered dataset, the DML cluster including a treatment model and an effect model, wherein each of the treatment and effect models receives the confounding variables for use in debiasing; receiving the treatment effect scores as an output from the DML cluster; and generating a visual representation of the treatment effect scores via a data visualization engine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2A is a block diagram illustrating example elements of a data extraction and aggregation service.

FIG. 2B is a block diagram illustrating example elements of a double machine learning (DML) service.

FIG. 3A is an example of a GUI screen displayed by a user portal or application used for submitting a request to determine the effects of a feature or treatment on a product.

FIG. 3B is an example of a GUI screen displayed by a user portal or other application used for displaying the effects of a feature or treatment on a product.

FIG. 4 is a flow diagram depicting an example method for determining the effect of a treatment on a product.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

Enterprises that develop and/or revise software programs often collect feedback and telemetry data from various user populations to assess the quality of the program, identify issues, and make release decisions. Software programs include many different features, some of which may have a positive impact on a user's experience with the software and some of which may result in a negative experience. In order to accurately evaluate a product and/or identify issues that require attention, it is important to study the effects of individual features of the program on user satisfaction. One manner in which a product can be evaluated is through utilization of surveys such as the NPS. In an NPS survey, users are asked to rate, on a numerical scale (typically 0-5 or 0-10), how likely they are to recommend the company, service, or product to others. Responses are categorized as promoter, passive, or detractor, based on whether the rating is above or below a predetermined threshold. NPS score is then derived from these labeled responses by subtracting the percentage of detractors from the percentage of promoters, resulting in a range from −100 to +100. Other methods of evaluating a product, service or feature may be employed for different types of products. For example, revenue may be used by some enterprises as a metric for measuring the success of a product, service or feature. In other examples, the incidents per million engaged units (IMEU) metric, NPSA (Net paid seats added) and/or cost related metrics are used for evaluating the success/failure of a product, service or feature.

As used herein, the term “characteristic” is used to refer to an attribute of a population, a product or a service and may include market segments, operating system types and/or versions, device types, UI languages, and build versions. The term “feature” as used herein refers to an option, functionality, task, or capability of a product or service. For example, the term “feature” may be used to refer to various tasks that are available for use in a software application. The term “confounder” or “confounding variable” is used to refer to an extraneous variable whose presence affects both the treatment (e.g., feature) and the outcome variable (e.g., NPS).

The metrics that are used for measuring the success and/or failure of a product or service are often closely correlated with increased customer loyalty and satisfaction. These measures are often also indicative of areas that require attention (e.g., a feature that needs to be removed, a feature that requires improvement, etc.). By measuring the effect of feature usage upon the value of the metric used for measuring the success of the product/feature, companies can make data-driven decisions to improve their products and services through, for example, in-product awareness campaigns, product enhancement, or feature modifications, leading to increased customer satisfaction, improved products and improved computer systems.

Currently, A/B experiments are often used to determine the impact of in-product features on a measure of success/failure such as NPS. However, in some scenarios, A/B experimentation and/or testing is not feasible or desirable for a variety of reasons. For example, if the features are already in production, creation of a treatment/control group is not possible, or creation of treatment group may lead to loss of business. In another example, randomizing availability of a feature use can result in differential user experiences, which is often undesirable. Moreover, when features cannot be randomized, users decide whether and how often to use them, making it challenging to determine the impact of feature usage upon the measure of success/failure (e.g. NPS). Furthermore, feature users may differ from non-users in measurable attributes, raising issues of confoundedness. As a result, it may be unclear if differences in the measure of success are due to feature usage or confounders such as demographics, the type of devices used, type of operating system installed on the device, other applications installed on the device, the amount of storage space available on the device, usage behavior and the like, and how these confounders impact feature usage.

One approach to address the issues of creating differential user experiences and of confoundedness is to apply a machine learning technique called double machine learning (DML). While use of DML models, as described above, has made it possible to estimate causal effects when A/B testing is not feasible, simply trying to utilize DML for predicting the effects of a feature on a measure of success for a product results in many technical challenges. Use of DML to estimate the effects of a feature on a product requires using product telemetry data. Product telemetry data is often recorded for each individual user at individual action levels, with highly dimensional data and volume which frequently reaches into the terabytes of data. Using this amount of data for DML requires significant use of computing resources, such as memory, processing power and bandwidth. Furthermore, in the current systems, use of DML to estimate the effects of a feature on a customer success/failure metric such as NPS requires a significant investment of time and labor from data experienced engineers or science teams for execution of the DML, due to the nature of in-product telemetry and business needs. However, enterprises often need to estimate causal effects for multiple scenarios or multiple products within a brief period, which adds additional complexity, as code changes must be made manually. Additionally, fulfilling these enterprise requirements necessitates repetition of data extraction and execution of the models, thereby prolonging the time needed to obtain results. Thus, there exists a technical problem of the inability of currently available systems to efficiently, quantitatively and accurately determine the effects of a feature on a product.

To address these technical problems and more, in an example, this description provides a technical solution that utilizes DML to analyze feature usage effects on a measure of success such as NPS in an efficient manner. This is achieved by implementing an extraction and aggregation process that consolidates telemetry, NPS data and confounding variables and uses the aggregated data as an input into an efficient modeling pipeline. The solution involves automation on triggering jobs on a compute cluster for model processing and debiasing using the confounding variables. The resulting output is used to generate a graph such as a heatmap for visualizing the significant positive and negative impacts of different treatments on the NPS of various scenarios (e.g., a specific filter on the source data such as filtering by geographic country like Japan) along with the intensity of usage of this feature. The resulting output (e.g., graph or heatmap) may be stored in a file that displays the results in a user interface (UI) screen that visualizes the effects of different features on the measure of success (e.g., NPS) for different characteristics. This may enable a user to easily determine the effects of various features of a product in different user populations and/or for different characteristics.

As will be understood by persons of skill in the art upon reading this disclosure, benefits and advantages provided by such implementations can include, but are not limited to, a ML/AI solution to the problems of lacking a technical mechanism for effectively determining the effects of a feature on a product. Solutions and implementations provided herein optimize the process of determining the effects of a feature on a product. This enables users and enterprises to quickly and accurately determine how a product feature affects the measure of success such as NPS, to identify potential issues with features and to address any detected issues. The benefits provided by these technology-based solutions yield improved software programs thus resulting in an overall improvement in computer systems. The technical effects at least include (1) improving the operation of computing systems by efficiently identifying problematic features; (2) improving the operation of computing systems that are used to determine the effects of a feature on a product by utilizing extraction and aggregation mechanisms that reduce the amount of memory, computing power and/or bandwidth required to identify the results; and (3) reducing the amount of time and labor required determine the effects of a feature on a product (4) educating users on features that delight them by making them more productive thus increasing retention and “life time value” of the customers.

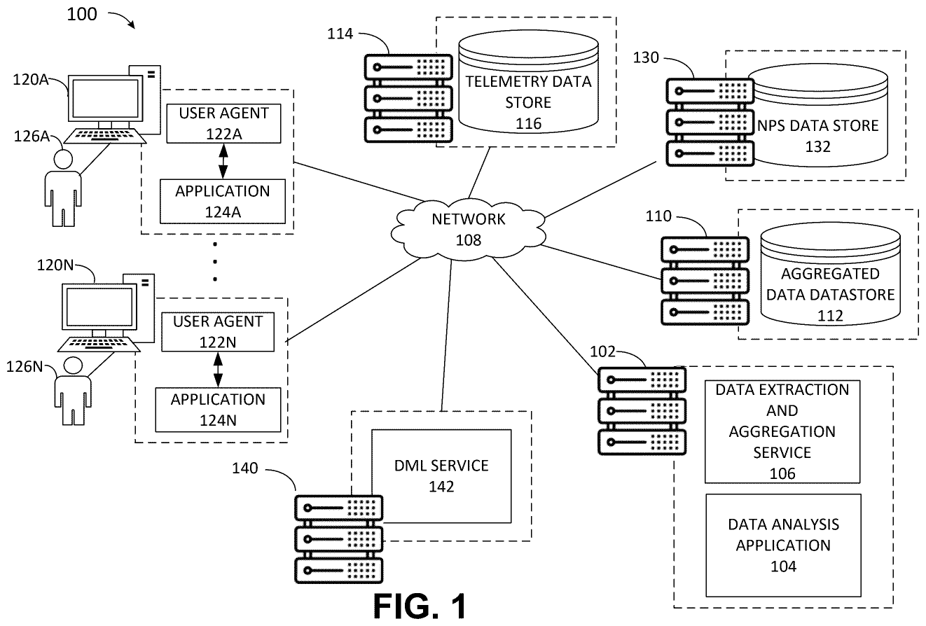

FIG. 1 illustrates an example system 100, upon which aspects of this disclosure may be implemented. The system 100 includes a server 102, a server 140, and servers 110, 114 and 130, and client devices 120A-120N (referred to collectively and/or individually, for ease of reference, as client device 120). Each of the servers 102, 110, 114, 130 and 140 may include a plurality of servers that work together to deliver the functions and services provided by each service or application. The servers 102 and 140 may operate as a cloud-based server for data extraction and aggregation services and DML services, respectively. The services offered by the data extraction and aggregation service 106 and DML service 142 may be offered via one or more applications such as data analysis 104. In some implementations, the servers 102 and/or 140 operate as a shared resource server located at an enterprise accessible by various computer client devices such as one or more of the client devices 120A-120N.

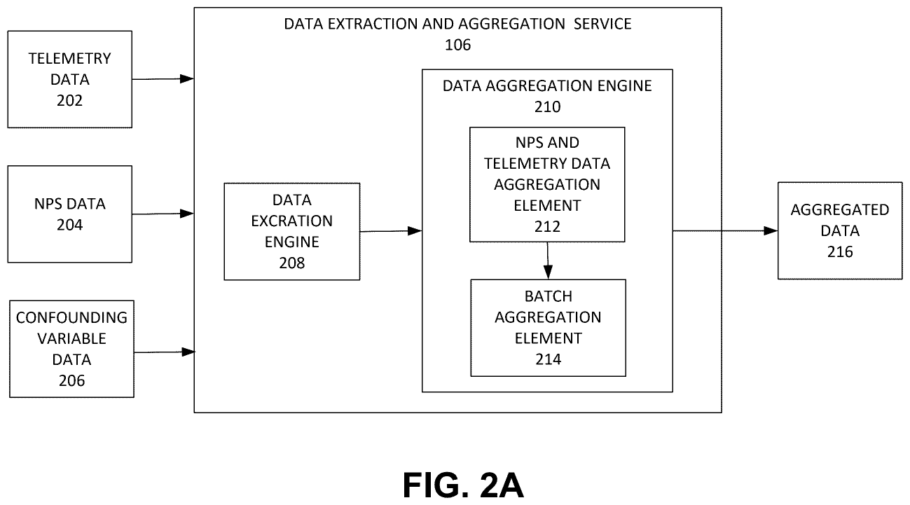

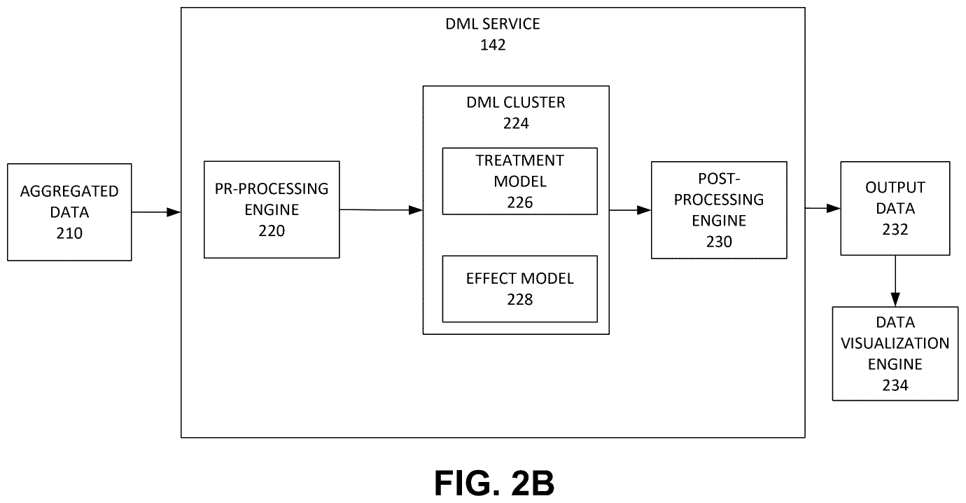

The server 102 includes and/or executes the data extraction and aggregation service 106 which extracts and aggregates data needed for determining effects of a feature on a measure of success of a product such as NPS. The data extraction and aggregation service retrieves data from one or diverse data sources such as the telemetry data store 116 and NPS data store 132, filters the received data, when needed, and aggregates the data. Various elements of the data extraction and aggregation service are discussed in more detail with respect to FIG. 2A.

The aggregated data store 112 functions as a repository in which the aggregated data is stored. The telemetry data store 116 is a data store that collects and stores telemetry data from the client devices 120 and/or telemetry data from one or more servers. The telemetry data may be collected routinely as part of infrastructure of the computer environment. For example, as users utilize various applications on the client devices 120, data related to the user of the applications is collected and stored in the telemetry data store 116. The NPS data store 132 collects and stores NPS data. The NPS data is collected when a user responds to an NPS survey or otherwise provides feedback regarding a product or feature (e.g., via an FPS survey). In some implementations, the NPS data stores an NPS score along with various parameters about the user who submitted the NPS scores. Some of these parameters are confounding parameters that affect the NPS score and as such are taken into consideration when determining the effects of the feature on the NPS score. The data may be stored in a columnar structure where each column corresponds to a different characteristic associated with the user who submitted an NPS score. The characteristics may include a user type, language, operating system code name and device manufacturer, among others. It should be noted that in collecting, retrieving, storing and analyzing user data, care is taken to ensure the user's privacy is protected.

Although shown as a single data store, each of the data stores 112, 116 and 132 may be representative of multiple storage devices and data stores which may be connected to each of the various elements of the system 100. Furthermore, although the data stores 112, 116 and 132 are shown as being part of the servers 110, 114 and 130, respectively, one or more elements (e.g., storage mediums) of each of the data stores 112, 116 and 132 may be provided in the same storage servers or other types of servers.

Each of the client devices 120A-120N are connected to various elements of the system 100 via a network 108. The network 108 may be a wired or wireless network(s) or a combination of wired and wireless networks that connect one or more elements of the system 100. In some implementations, the network 108 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network is coupled to or includes portions of a telecommunications network for sending data in a variety of different communication protocols. In some implementations, the network includes Bluetooth® communication networks or a cellular communications network for sending and receiving data including via short messaging service (SMS), multimedia messaging service (MMS), hypertext transfer protocol (HTTP), direct data connection, WAP, email, and the like.

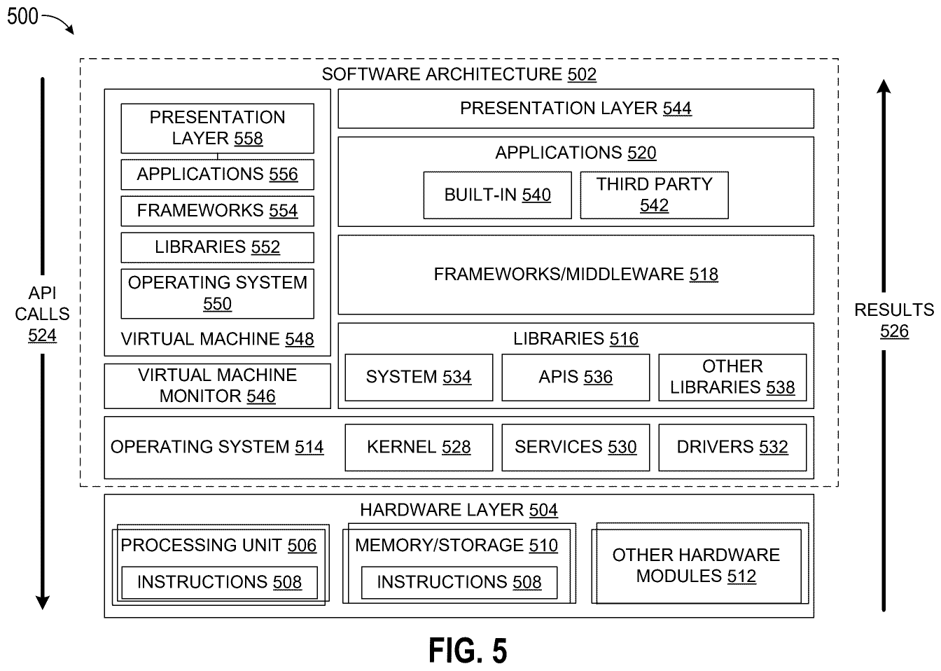

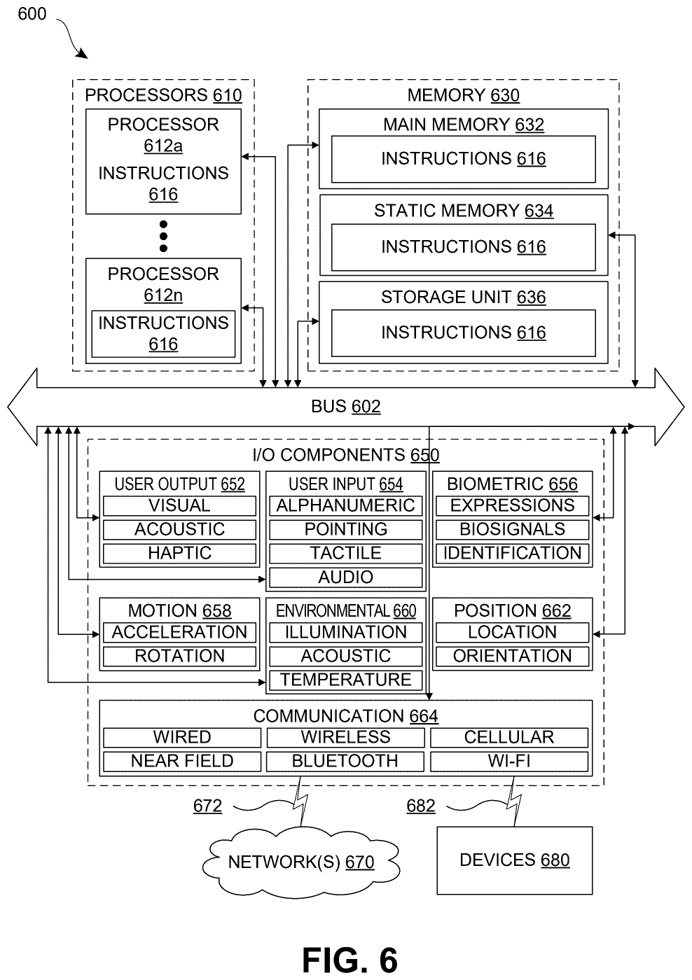

The client devices 120A-120N may be personal or handheld computing devices having or being connected to input/output elements that enable a user to interact with various applications and (e.g., application 104 or applications 124A-124N). Examples of suitable client devices 120A-120N include but are not limited to personal computers, desktop computers, laptop computers, mobile telephones, smart phones, tablets, phablets, smart watches, wearable computers, gaming devices/computers, televisions, and the like. The internal hardware structure of a client device is discussed in greater detail in regard to FIGS. 5 and 6.

Each of the client devices 120A-120N are associated with a different user such as users 126A-126N (referred to collectively as user 126). The applications 124A-124N represent applications used by users 126A-126N for performing various tasks. For example, applications 124A-124N may be any application that the users 126 uses on the client device 120 to view or edit a document, schedule events, communicate with different users, or play a game. As such applications 124A-124N may be communication applications (e.g., email application, virtual meeting application, instant messaging application), calendar application, social media application, productively application (e.g., word processing application, presentation application, etc.) and the like. Applications 124A-124N are native applications that are installed on one of the client devices 120. While only native applications are depicted in FIG. 1, user 126 may utilize similar applications that are executed on an online server 110 (and are provided via an online service).

In some implementations, web applications communicate via the network 108 with a user agent 122A-122N, such as a browser, executing on the client device 120. The user agent 122A-122N may provide a UI that allows the user to interact with the online application. When the user 126 makes use of a native application such as the applications 124A-124N or an online application via the user agent 122A-122N, telemetry data related to the user's use of the applications is collected and stored in the telemetry data store 116. Because of the significantly large number of actions users typically take on a given application and the large number of users from which telemetry data may be collected, the amount of telemetry data collected and stored for each given time period is very large. As a result, processing and utilizing such a large amount of data to determine the effects of an application feature on a success metric such as the NPS requires extensive computer resources. The technical solution presented herein makes use of the data extraction and aggregation service 106 to aggregate this data before it is used for analysis, thus significantly reducing the amount of computing resources required to perform the analysis.

In some implementations, a client device 120 is associated with a user 126 who is a team leader, manager or troubleshooting engineer responsible for making business decisions or managing faulty/underperforming features. The user 126 may utilize an application such as the data analysis application 104 or a local version of the data analysis application 104 (not shown), and/or a DML service application (not shown) to submit a request for analyzing the effects of a given feature on a selected metric (e.g., NPS). The request may include additional parameters such the application/product the feature is associated with and the period of time for which analysis should be performed.

Once the request is submitted, the data extraction and aggregation service 106 extracts telemetry data and NPS data for the requested period, and processes and aggregates the data, before storing the aggregated data in the aggregated data datastore 112. The user 126 is then able to access a program and/or a user interface associated with the DML service 142 to submit a request for processing the aggregated data via the DML service 142 to obtain the requested results. In some implementations, the aggregated data is automatically submitted to the DML service 142 for processing. The result is then generated and stored in a data store such as data store associated with the DML service or the data store 112 for later viewing and access. The user can then access and review the results, as needed.

The DML service 112 may operate as the backend engine for analyzing the aggregated data and determining the effects of a feature on a product. The DML service 112 may operate to receive the aggregated data, generate an input prompt for a DML cluster, submit the prompt to the DML cluster and receive an output from the DML cluster. In an example, the DML service 112 stores all intermediate inputs such that users can view the data, if desired. The output may then be post-processed to generate the desired result. Various elements of the data extraction and aggregation service are discussed in more detail with respect to FIG. 2B.

FIG. 2A is a block diagram illustrating example elements of a data extraction and aggregation service. The data extraction and aggregation service 112 includes a data extraction engine 208 and a data aggregation engine 210. The data extraction engine 208 determines based on a request and/or based on parameters selected for the request the types of telemetry data, NPS data and/or confounding variables to extract. In some implementations, this involves receiving a user selected period of time for which data should be retrieved. This involves, in some implementations, receiving a request that identifies a given date range (e.g., start data and end date) for examining the effects of a feature or other treatment parameter, and determining, based on a predetermined selection or based on user selected parameters, the time period for which NPS data and telemetry data should be retrieved. For example, if the request is for examining the effects of a feature or other treatment parameter from Feb. 1, 2024, to Mar. 1, 2024, telemetry data for a period of 20 days prior to the start date of Feb. 1, 2024 up until the end date of Mar. 1, 2024 is retrieved (for estimates of February 1-March 1, telemetry data is extracted from January 11 to March 1) to accurately and efficiently examine the parameters that may have affected the NPS ratings. The amount of data used is based on sample size (low sample size generates results that are not statistically significant and as such not useful). Additionally, data extraction engine 208 determines that NPS data for the requested time period (e.g., from Feb. 1, 2024, to Mar. 1, 2024) should be extracted. This provides NPS data and provides further data from a period prior to the survey to account for proper usage history.

In some implementations, an existing dataset is refreshed so that faster analysis can be performed without having to re-extract the data. That is because data extraction is an expensive and lengthy process since it requires aggregating a massive amount of telemetry data. By refreshing the data based on a predetermined schedule, the system ensures updated data is available when/if there is a need to run the models with the latest telemetry data.

In some implementations, the data extraction engine 208 also determines that type of telemetry data to extract. For example, the request may identify the type of application that includes the feature of interest and the data extraction engine 208 may identify the application as a category of data for which telemetry data should be retrieved. In another example, the request may simply identify the feature, and the data extraction engine 208 may itself identify the application to which the feature relates. Other data categories that the data extraction engine 208 may identify include device type, user type, and various other parameters that may be directed or indirectly related to the feature or application being examined.

The telemetry and NPS data may include confounding variables and data associated with them that should be examined to accurately determine the effects of a feature on a product. Confounding variables may include categories such as region, usage intensity, user type, user device and the like. These are parameters that potentially influence the output and the treatment and as such should be accounted for. In some implementations, the request identifies one or more of the confounding variables.

Once the data extraction engine 208 identifies the types of telemetry data, NPS data and confounding variables that should be retrieved and the time periods for which each of these types of data should be retrieved, the data extraction engine 208 retrieves the required data from the telemetry data 202, NPS data 204 and confounding variable data 206. The telemetry data 202 is stored in a telemetry data store, as discussed above. Similarly, the NPS data 204 is stored in an NPS data store. Confounding variables data 206 may be stored in the NPS data store and/or in the telemetry data store. For example, NPS data often includes data about other parameters associated with the user who provided feedback (e.g., responded to a survey) such as the user type, user device type, region, and the like. Telemetry data may also include such data. Thus, data associated with the identified confounding variables may be retrieved from the NPS data store and/or the telemetry data store. Each of the extracted telemetry data, NPS data and confounding variables data is associated with a user identification (user ID).

In some implementations, the data extraction engine 208 retrieves the data in multiple batches. To achieve this, the data extraction engine 208 submits a series of batched jobs. Each job processes a unique date range of NPS ratings and their corresponding prior telemetry events. This approach ensures that the telemetry data is relevant to users' NPS ratings and improves pipeline efficiency by keeping the window of extracted telemetry records close to the date of the NPS record. This also addresses the challenge in the large volume of in-app telemetry data needing to be processed, by processing the data in smaller batches, which may be processed consecutively or simultaneously.

Each of the retrieved NPS and telemetry data batch is then provided to the data aggregation engine 210 which includes an NPS and telemetry aggregation element 212 and a batch aggregation element 214. The NPS and telemetry aggregation element 212 aggregates the telemetry and NPS data into the same data structure. This may involve use of a common schema that extracts data from both the NPS data set and the telemetry data set and includes fields for confounding variables. The common schema may be reusable for different applications and/or features. In this manner, the system can be used for new products and/or new features with little or no change. As a result, the system is adaptable and can be easily extended to various types of products. To aggregate the data into the same data structure, the NPS and telemetry aggregation element 212 aggregates utilizes the user ID field to identify data belonging to the same user and then aggregates the telemetry data for the user with the NPS data (e.g., into the same row with different columns for different telemetry and NPS variables).

In some implementations, aggregation includes aggregating the telemetry actions into groups. This is because telemetry data for actions that are performed in an application can be significantly large and/or detailed. Many applications have a significantly large number of actions that can be performed within the application (e.g., Excel has about 5000 different available actions). To simplify and aggregate the data, the data aggregation engine 210 may group various actions into the same group. In some implementations, the groups are predetermined, for example, by the product team (e.g., the engineering team for the application). Thus, the data aggregation engine 210 may utilize pre-established lists to group the actions in the telemetry data into one or more groups. The resulting data set is smaller and easier to process. In some implementations, to ensure privacy is preserved, the NPS and telemetry aggregation element 212 removes user identifiers (e.g., user ID) from the aggregated data.

The slices of joined telemetry and NPS data produced by the batched jobs are then consolidated into a single dataset, by the batch aggregation element 214, thus facilitating obtaining telemetry, confounders, and NPS records for a given scenario or treatment during data modeling. The joined data is then provided as the aggregated data 216 as an output. The output dataset includes NPS ratings, in-product telemetry, and confounders for a given time period. The aggregated data 214 is then stored in a storage medium such as the aggregated data datastore 112 of FIG. 1. In an example, the consolidated dataset is written to Parquet storage medium in a virtual cluster due to Parquet's fast query performance and reduced input/output (I/O) operations. That is because compared to CSV and JavaScript Object Notation (JSON) formats, Parquet has comparatively lower storage needs given the size of the input dataset and is more efficient in reading data. However, many other storage mediums and/or formats may be used.

FIG. 2B is a block diagram illustrating example elements of a DML service used in determining the effects of a feature on a product. The DML service 142 which includes the modeling architecture used ne to determine the effects of a treatment or feature on a product includes a pre-processing engine 220, DML cluster 224 and post-processing engine 230. The DML service 142 accesses the aggregated data 210 (e.g., reads the data through service principle authentication) and utilizes the data to provide an output data 232. In an example, the aggregated data 210 which is stored in a storage medium is used as an input to the DML service 142 along with a request that specifies the filters that need to be used for running the different models. That is because the aggregated data 210 may be reused for different types of determinations and/or at different times. For example, the aggregated data 210 may be used for different types of users, in different regions, etc. In this manner, after the initial processing of extracting the data, aggregation of the data is applied according to requirements, thus making the process efficient (the aggregation could be done post-extraction but would require larger compute to run). With this, the data can be reused to reduce the amount of time and resources required to execute the data extraction and aggregation process. The data can also be refreshed based on a given cadence (e.g., weekly) so that it persists, and it is up to date for consumption.

The aggregated data 210 is first provided to the pre-processing engine 220 to undergo pre-processing. Preprocessing is used to reduce noise in predicting the outcome and/or to reformat the data into a form interpretable by the model. The pre-processing engine 220 utilizes the dataset of extracted telemetry, confounders, and NPS records, and utilizes various mechanism on the dataset to generate a filtered dataset with debiasing fields, a properly formatted outcome variable, and treatment fields for evaluation. If scenario specific treatment effect scores are desired, the pre-processing engine 220 performs data filtering to enhance the efficiency and accuracy of the process. Some examples of filters that may be used include filtering for commercial users in a specific country (e.g., Japan or United States), filtering for users with an Operating system (OS) build after a certain version, users with a tenure of more than 2 years, etc. During data filter, if for specific filter, a feature or action does not have enough variance, the field may be dropped from the analysis by the pre-processing engine 220. In some implementations, the data is filtered once for each scenario of interest during the reading process to reduce the computational cost by reducing the amount of data stored in memory. This step may be performed once for each scenario of interest specified in the input parameters.

Once the aggregated data has been filtered as needed, it undergoes transformation. An example pipeline may include transformations such as feature scaling, normalization of fields, grouping of rarely occurring categorical values, and conversion of categorical values to numeric fields through one-hot encoding. In some implementations, the pre-processing engine 220 also modifies the telemetry data to create columns that are related to the feature/treatment of interest, ensuring that only the current feature/treatment being evaluated is included in the treatment effect estimation, and other telemetry usage signals are included in the confounders. Pre-processing can vary depending on the desired outcome. For example, when there are different groups of interests, the data is filtered for each group of interest so that unnecessary data is not stored in memory. Pre-processing also includes normalization. For example, the pre-processing engine 220 may normalize user actions based on their usage days to account for difference in use intensity. Thus, the data is reformatting in a way that the model can understand. For example, the pre-processing engine 220 may create one hot encoding by converting string variables to numeric fields. In an example, for the user region field, a field labeled user region US is created with a value of 0 for the field indicating the user is not in the U.S., and a value of 1 indicating that the user is located in the U.S.

In an example, each treatment estimate is submitted as a separate job to the DML cluster 224, which reduces the time to insight by running multiple independent modeling jobs in parallel. Each job is then transmitted to the DML cluster 224. Each model being executed on the DML cluster 224 is estimating the treatment effect of use of a single action or an action category for a given cohort and can be run for regular users of the action/category or for frequent users of the action/category. The jobs that are executed in the DML cluster depend on user-selected parameters, as well as which treatments remain in the data after pre-processing. For example, if a user seeks to produce treatment effect scores for the following 3 features in an application for 2 user categories (e.g., users with tenure of 2+ years, and less than a year), the DML service would produce a model for each feature and category combination, provided that the category has use of the feature that remains in the dataset after pre-processing.

The DML cluster 224 fits a treatment model 226 and an effect model 228. Together the treatment model 226 and effect model 228 debiase the treatment estimate for potential confounders by combining machine learning algorithms with linear regression. DML combines the flexibility of ML algorithms with the power of statistical inference coming from linear regression to eliminate regularization and overfitting bias that sometimes happens when machine leaning is used for causal inference. DML is used for estimating treatment effects when potential confounders/controls (factors that simultaneously had a direct effect on the treatment decision in the collected data and the observed outcome) are observed but are either too many for classical statistical approaches to be applicable or their effect on the treatment and outcome cannot be satisfactorily modeled by parametric functions. In the case of determining the effects of a feature on an NPS score, there are many confounding variables which may be affecting the NPS score. Thus, by using DML the effects of these confounding variables can be correctly considered. DML first estimates the outcome and the treatment from the confounders and then combines the residuals of the two predictive models in a final stage estimation that may include heterogeneous treatment effects. Thus, while the DML cluster 224 displays two models 226 and 228, the DML cluster also includes a final stage estimation process. The models 226 and 228 accept different forms of treatment specifications (continuous and binary) and treatment heterogeneity can be included in the last stage specific functional forms can be incorporated.

When confounding variables impacting both treatment (e.g., use of telemetry) and outcome (e.g., NPS) are present, the relationship between confounders, treatment, and outcome can be understood via the following equations:

$$T = {m}_{0} ( X ) + ω \qquad ( 1 )$$

$$NPS = Θ T + {g}_{0} ( X ) + μ \qquad ( 2 )$$

In equation (1), T represents the expected value for the treatment given a function of the confounders (m₀(X)) and ω represents the error term or the unexplained variation in the treatment effect after accounting for the confounders' influence. In equation (2), the NPS outcome is measured as the sum of the average treatment effect (ΘT), a function of the confounding variables (g₀(X)), and an error term (μ) representing the unexplained variation in NPS after accounting for the influence of the average treatment and confounders. It should be noted that the above equations correspond to a single model fit. If there are multiple telemetry actions that are being examined, the models needs to be executed once for each (e.g., if there are 10 telemetry actions, 10 models need to be run. If there are 10 telemetry actions for 3 scenarios/filters, 30 models need to be executed, etc.) The DML cluster 224 accounts for these relationships through the following equations.

$$\hat{ω} = T - {\hat{m}}_{0} ( X ) \qquad ( 3 )$$

$$\hat{ϵ} = NPS - {\hat{l}}_{0} ( X ) \qquad ( 4 )$$

$$\hat{ϵ} = Θ \hat{w} + v \qquad ( 5 )$$

In equation (3), the unexplained treatment variability \hat{ω} is estimated by taking the difference between the observed treatment outcome T and the expected value for T given the confounding variables m₀(X). Equation (4) estimates the unexplained outcome variability \hat{∈} by taking the difference between the observed value for NPS and the expected value for NPS, given the confounding variables (\hat{l}₀(X)). Lastly, the residuals for the treatment and outcome are used to estimate how much of the variability in equation 4 is explained by equation 3.

After the inputs are provided to the DML cluster 224, estimates for various percentiles (e.g., the 25th, 50th, and 75th percentiles) for the treatment effect are returned as an output for each modeling job, along with p-values, upper and lower bounds for the scores, and/or confidence levels (e.g., 95% confidence level). Each of the models creates a single row csv file that includes all of these outputs. These metrics are then consolidated from all the model runs and filtered based upon their p-value during post-processing.

The ML models implemented by the DML service 112 may be fitted using training data sets for specific types of data (e.g., NPS and telemetry data and/or labeling) to provide initial and ongoing training for each of the models. In one implementation, the training mechanism uses labeled training data to train one or more of the models via two stage ML models. In the first stage, the ML model predicts the treatment and in the second stage it predicts outcome of interest given the predicted treatment. In some implementations, the models are trained for specific types of measure of success/failure (e.g., NPS, IMEU, cost, etc.). The models may be trained to minimize error within the estimate of the outcome variable. As a result, the models are trained to generate an estimate of the measure of success/failure (e.g., NPS) as closely as possible. In some implementations, the training data is a dataset similar to data generated after the pre-processing step of FIG. 2A.

In different implementations, a training system may be used that uses training data obtained from a training data repository or from device-generated data. The generation of both the trained ML model may be referred to as “training” or “learning.” The training system may include and/or have access to substantial computation resources for training, such as a cloud, including many computer server systems adapted for machine learning training. In some implementations, different underlying models, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model is produced.

The training data may be continually updated, and one or more of the ML models used by the system can be revised or regenerated to reflect the updates to the training data. For example, the training data may be updated based on new user feedback. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data, care must be taken to comply with privacy guidelines and regulations. For example, options may be provided to seek consent (e.g., opt-in) from users for collection and use of user data, to enable users to opt-out of data collection, and/or to allow users to view and/or correct collected data. Certain regulations do not permit export of data outside of specific geographic boundaries, therefore the DML model can be configured to run within the specific geographic environment as a separate batch process. User identifying information may also be removed from training data and from the data used as an input to the trained models.

For telemetry to have a statistically significant treatment effect upon NPS, the p-value associated with its effect estimate must be less than or equal to a set threshold. In an example estimating the effect of an in-product telemetry action upon NPS, a threshold of 0.05 might be chosen for the p-value to be conservative. For example, enterprise leaders may be more concerned with falsely predicting that the treatment has an effect (and thus wasting marketing resources for in-app campaigns or engineering resources for product changes) than they are with failing to identify a treatment as having a significant effect upon outcome. Thus, to accurately identify and utilize the treatment effect of a feature on a product, statistical analysis may need to be performed. This is achieved by utilizing the post-processing engine 230. In some implementations, post-processing also includes consolidating all of the results of the individual model tests and impact estimates that are produced by the individual DML runs. Each of the treatment and effect models creates a file that includes p values, among other attributes. In some implementations, the output provided by the models also includes a parameter that indicates whether the p value is statistically significant for at least one of the population groups. The post-processing engine 230 then uses this information to filter for statistically significant treatment effects (e.g., based on a given threshold) and aggregates the results in one dataset.

Once the calculations are completed, the post-processing engine 230 provides the output data 232 as an output of the modeling process. The output data 232 includes a calculated parameter that estimates the effects of the treatment on the measure of success (e.g. NPS) for various population segments (based on the inputs provided by the user). In some implementations, the output data 232 is stored in a data storage medium for later retrieval and visualization. The outputs may be provided to the data visualization engine 234 for visualization, as needed. The data visualization engine 230 may use one or more known visualization techniques for visualizing the results to a user. As an example, the data visualization engine 230 may utilize a plug and play visualization engine. For example, the data visualization engine 230 may utilize Microsoft® Power BI, Tableau or a static website using visualization libraries such as D3, Bootstrap and the like. In some implementations, enterprises can use a data visualization mechanism of their choice. For example, third party users may receive the output from the DML service 142 and utilize a chosen data visualization mechanism to display the results. In some implementations, the output data is visualized into a chart or graph (e.g., a heatmap) as further discussed below. In an example, results can be presented across time (e.g., the model is executed this month, and the result is compared with last month results to see changes/trends).

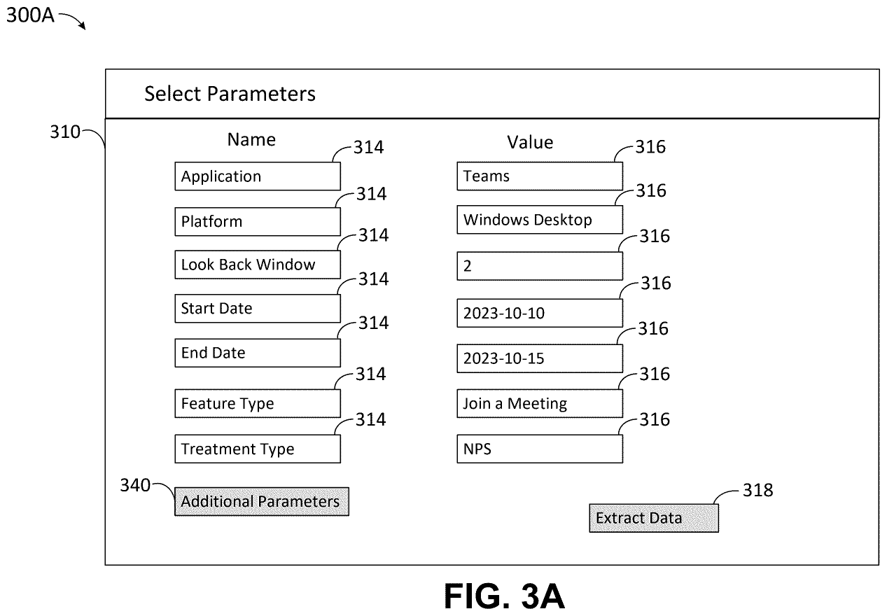

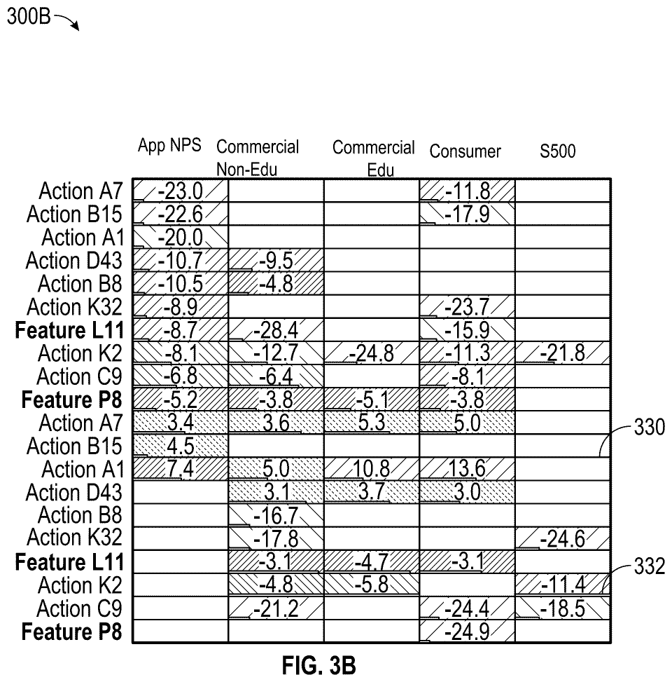

FIG. 3A is an example of a GUI screen displayed by a user portal or application used for submitting a request to determine the effects of a feature or treatment on a product. In an example, the GUI screen 300A of FIG. 3A is a display screen of a data analysis application which can be used by an administrator of an enterprise to review and analyze effects of different treatments on products and services. In some implementations, the data analysis application communicates with a backend service such as the data extraction and aggregation service 106 of FIG. 1 to submit a request for extracting data that will be later used in determining the effects of a feature or treatment on a product.

The GUI screen 300A includes a parameter selection pane 310 that lists a number of selectable parameters for which values may be selected. The selection pane includes UI elements 314 which display the names of variable selectable parameters a. The user can utilize the UI element 316 to enter a desired value for a selected parameter. For example, when the selected parameter is application, the user can enter the desired value (e.g., Teams) in the corresponding UI element 316. The absence of a value in the UI element 316 is interpreted as a desire to use the default value. In some implementations, a default value is displayed in one or more of the UI elements 316 and the user is able to change the default value by simply selecting (e.g., clicking on) a desired UI element 316. In some implementations, multiple values can be selected for each of the parameters. As depicted, some of the parameters that can be selected are application, platform (e.g., Windows Desktop), look back window, start and end dates, feature type (e.g., join a meeting feature in Teams), and treatment type (e.g., NPS). When feature type is not selected (e.g., the user does not know the feature name they are interested in), the user may be able to select if the analysis should be performed for features, action data or both, in which the system uses all available signals for features, action data or both to perform the modeling. More parameters may be selected by selecting the UI element 320, which may display a new GUI screen with more/different selectable parameters and/or may add more selectable parameters to the GUI screen 300A.

Once all the desired parameters have been selected and their values are chosen, the UI element 318 can be utilized to start the data extraction and aggregation process. After the request is submitted, the system begins the process, which depending on the size of the data may take a few hours. The user can then check the storage medium at which the aggregated data will be stored to determine if the data is ready. In some implementations, the user receives a notification when the data is prepared. It should be noted that the UI elements 314, 316, 318 and 320 are only example UI elements. Other types of UI elements are contemplated and may be utilized.

After the data extraction and aggregation process is complete and the data is stored in a designated storage medium, the user can select the data for that is read by the DML service from the designated storage medium. In some implementations, when the data is prepared, it is automatically transmitted to the DML service for processing. After processing by the DML service, the output of the DML process is stored in a storage medium for later access by the user. In some implementations, the user can view the resulting calculations via a diagram such as a graph or a chart. Alternatively, the results may be displayed via different types of diagrams. In some examples, the results may be displayed via a table or a heatmap. In another example, raw results and/or intermediate outputs can be retrieved and/or displayed.

FIG. 3B is an example of a GUI screen displayed by a user portal or other application used for displaying the effects of a feature or treatment on a product. GUI screen 300B of FIG. 3B depicts an example table (e.g., heatmap) 330 provided as an output. The table 330 includes a number of rows, each of which represents a feature of interest for which a determination of how the feature affects the product for given segments (present in the columns) of data was made. In an example, the feature “Feature L11” affected the App NPS segment of the data negatively, by −8.7 points. The numerical value represent the value by which the system estimates the feature affected the product (e.g., affected the NPS score of the product). A positive value indicates that the feature had a positive effect, while a negative value indicates that the feature had a negative effect on the product. Depending on the relative value of each number, the color of the cell containing the number is changed to present a heatmap that can easily identify problems and/or positive influencers. For example, a brighter color may be used to display larger positive values, while a darker color is used to display larger negative values. Another visual cue such as a bar 332 may be used to represent the percentage of the user population utilizing the feature. If the bar is short, that indicates that a small portion of the user population used the feature during the examined time period, while a longer bar indicates a larger portion of the population used the feature.

The visualization screens of the technical solution provided herein enable the user to easily identify how different features affect a product in the users' views. This enables administrators and developers to quickly identify features that require improvement and/or features that are underutilized while having a positive effect. For example, table 330 shows that the feature “Action B15” has a positive value of 4.5 with a very small bar. This indicates that while this feature has a significantly positive value, it is being underutilized. The developer team may use this information to improve accessibility of the feature, provide more information about the feature or create a campaign that highlights the feature within the product. Features that indicate large negative effects can be studied and/or improved.

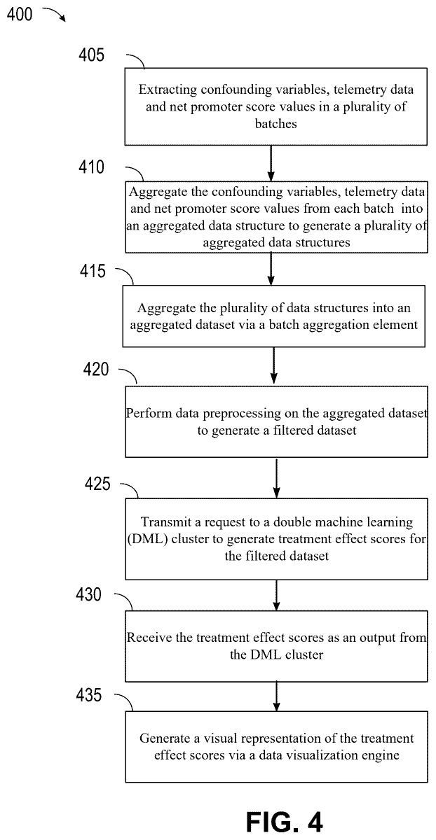

FIG. 4 is a flow diagram depicting an example method for determining the effect of a treatment on a product. In an example, one or more steps of method 400 may be performed by a data extraction and aggregation service such as the data extraction and aggregation service of FIGS. 1 and 2A and/or a DML service such as the DML service of FIGS. 1 and 2B.

At 405, method 400 begins by extracting confounding variables, telemetry data associated with the use of the product, and net promoter score values associated with the product in a plurality of batches from one or more data stores. This may be done by utilizing a data extraction engine. Once all the required data is extracted, method 400 proceeds to aggregate the confounding variables, telemetry data and net promoter score values from each batch of the plurality of batches into an aggregated data structure to generate a plurality of aggregated data structures, at 410. Each of the aggregated data structure of the plurality of data structures corresponds to one batch of the plurality of batches.

The generated aggregated data structures are then appended to make final dataset via a batch aggregation element, at 415. This may be achieved by utilizing a batch aggregation element that horizontally concatenates (i.e., a union operation) the different data structures into one file. In some implementations, this file is stored in a data storage medium for later use and reuse. Once the data is prepared, method 400 proceeds to perform data preprocessing on the aggregated dataset to generate a filtered dataset with at least one of one or more debiasing fields, an outcome variable, and one or more treatment fields, at 420. This may be done once a request for executing the DML cluster on a generated output file is received. In some implementations, performing data preprocessing on the aggregated data set includes feature scaling, normalization of one or more fields, grouping of rarely occurring categorical values, and conversion of categorical values to numeric fields through one-hot encoding. Performing data preprocessing on the aggregated data set includes modifying the telemetry data to create one or more columns that are related to a treatment of interest. The type of preprocessing depends upon input data and the purpose for which the analysis is being performed. A column is created for each action or feature used. A single one of these columns is used as a treatment at a time, and the rest of the action or feature columns are used as confounders.

Once pre-processing is complete, method 400 proceeds to transmit a request to a DML cluster to generate treatment effect scores for the filtered dataset, at 425. The DML cluster includes a treatment model and an effect model, where each of the treatment and effect models receives the confounding variables for use in debiasing. Method 400 then proceeds to receive the treatment effect scores as an output from the DML cluster, at 430, before generating a visual representation of the treatment effect scores via a data visualization engine, at 435. In some implementations, the visual representation displays significant positive and negative impacts of different treatments on the net promoter score of various scenarios. In an example, the visual representation is a heatmap. Furthermore, the visual representation may include a visual cue for displaying a frequency of use of a feature.

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to perform functions of:
extracting telemetry data and net promoter score values in a plurality of batches from one or more data stores, at least one of the telemetry data or the net promoter score values including confounding variables;
aggregating the telemetry data and net promoter score values from each batch of the plurality of batches into an aggregated data structure to generate a plurality of aggregated data structures, each aggregated data structure of the plurality of data structures corresponding to a batch of the plurality of batches;
appending the plurality of data structures to generate an aggregated dataset via a batch aggregation element;
performing data preprocessing on the aggregated dataset to generate a filtered dataset with at least one of one or more debiasing fields, an outcome variable, and one or more treatment fields;
transmitting a request to a double machine learning (DML) cluster to generate treatment effect scores for the filtered dataset, the DML cluster including a treatment model and an effect model, wherein each of the treatment and effect models receives the confounding variables for use in debiasing;
receiving the treatment effect scores as an output from the DML cluster; and
generating a visual representation of the treatment effect scores via a data visualization engine.

2. The data processing system of claim 1, wherein the visual representation displays significant positive and negative impacts of different treatments on the net promoter score of various scenarios.

3. The data processing system of claim 1, wherein the visual representation is a heatmap.

4. The data processing system of claim 1, wherein the visual representation includes a visual cue for displaying a frequency of use of a feature.

5. The data processing system of claim 1, wherein the treatment effect represents an effect of a feature on a product.

6. The data processing system of claim 1, wherein performing data preprocessing on the aggregated data set includes at least one of feature scaling, normalization of one or more fields, grouping of rarely occurring categorical values, and conversion of categorical values to numeric fields through one-hot encoding.

7. The data processing system of claim 1, wherein performing data preprocessing on the aggregated data set includes modifying the telemetry data to create one or more columns that are related to a treatment of interest.

8. The data processing system of claim 1, wherein the output from the DML cluster undergoes post-processing, the post-processing including filtering for statistically significant treatment effect scores.

9. The data processing system of claim 1, wherein the output from the DML cluster undergoes post-processing, the post-processing including aggregating the output into one output dataset.

10. A method for determining the effect of a treatment on a product, comprising:
extracting telemetry data from a use of the product, and net promoter score values associated with the product in a plurality of batches, at least one of the telemetry data or the net promoter score values including confounding variables;
aggregating the telemetry data and net promoter score values from each batch of the plurality of batches into an aggregated data structure to generate a plurality of aggregated data structures, each aggregated data structure of the plurality of data structures corresponding to a batch of the plurality of batches;
appending the plurality of data structures to generate an aggregated dataset via a batch aggregation element;
performing data preprocessing on the aggregated dataset to generate a filtered dataset with at least one of one or more debiasing fields, an outcome variable, and one or more treatment fields;
transmitting a request to a double machine learning (DML) cluster to generate treatment effect scores for the filtered dataset, the DML cluster including a treatment model and an effect model, wherein each of the treatment and effect models receives the confounding variables to for use in debiasing;
receiving the treatment effect scores as an output from the DML cluster; and
generating a visual representation of the treatment effect scores via a data visualization engine.

11. The method of claim 10, wherein the visual representation displays significant positive and negative impacts of different treatments on the net promoter score of various scenarios.

12. The method of claim 10, wherein the visual representation is a heatmap.

13. The method of claim 10, wherein the treatment effect represents an effect of a feature on a product.

14. The method of claim 10, wherein performing data preprocessing on the aggregated data set includes at least one of feature scaling, normalization of one or more fields, grouping of rarely occurring categorical values, and conversion of categorical values to numeric fields through one-hot encoding.

15. The method of claim 10, wherein the output from the DML cluster undergoes post-processing, the post-processing including filtering for statistically significant treatment effect scores.

16. The method of claim 10, wherein performing data preprocessing on the aggregated data set includes modifying the telemetry data to create one or more columns that are related to a treatment of interest.

17. A non-transitory computer readable medium on which are stored instructions that, when executed, cause a programmable device to:
extracting telemetry data, and net promoter score values in a plurality of batches from one or more data stores, at least one of the telemetry data or the net promoter score values including confound variables;
aggregating the telemetry data and net promoter score values from each batch of the plurality of batches into an aggregated data structure to generate a plurality of aggregated data structures, each aggregated data structure of the plurality of data structures corresponding to a batch of the plurality of batches;
appending the plurality of data structures to generate an aggregated dataset via a batch aggregation element;
performing data preprocessing on the aggregated dataset to generate a filtered dataset with at least one of one or more debiasing fields, an outcome variable, and one or more treatment fields;
transmitting a request to a double machine learning (DML) cluster to generate treatment effect scores for the filtered dataset, the DML cluster including a treatment model and an effect model, wherein each of the treatment and effect models receives the confounding variables for use in debiasing;
receiving the treatment effect scores as an output from the DML cluster; and
generating a visual representation of the treatment effect scores via a data visualization engine.

18. The non-transitory computer readable medium of claim 17, wherein the visual representation displays significant positive and negative impacts of different treatments on the net promoter score of various scenarios.

19. The non-transitory computer readable medium of claim 17, wherein the visual representation is a heatmap.

20. The non-transitory computer readable medium of claim 17, wherein the visual representation includes a visual cue for displaying a frequency of use of a feature.
